(19) United States
(12) Patent Application Publication
(10) Pub. No.: US 2026/0237844 A1
(43) Pub. Date: Aug. 13, 2026

(54) ENERGY STORAGE APPARATUS

(71) Applicant: GS Yuasa International Ltd., Kyoto-shi (JP)

(72) Inventor: Atsuyuki KONISHI, Kyoto-shi (JP)

(21) Appl. No.: 19/637,178

(22) Filed: Apr. 2, 2026

Related U.S. Application Data
(63) Continuation of application No. PCT/JP2024/032769, filed on Sep. 12, 2024.

(30) Foreign Application Priority Data
Oct. 6, 2023 (JP) 2023-174496

(51) Int. Cl. H01M 50/30; H01M 50/209; H01M 50/262

(52) U.S. Cl. CPC H01M 50/394; H01M 50/209; H01M 50/262

(57) ABSTRACT

An energy storage apparatus includes an energy storage device, a case that accommodates the energy storage device and that includes a through hole, and a connecting portion positioned in the case to connect at least two elements in the case. The through hole allows ventilation between an inside and an outside of the case. At least a portion of the connecting portion is located in the through hole when viewed from a penetration direction of the through hole.

### CROSS REFERENCE TO RELATED APPLICATIONS

This application claims the benefit of priority to Japanese Patent Application No. 2023-174496 filed on Oct. 6, 2023 and is a Continuation Application of PCT Application No. PCT/JP 2024/032769 filed on Sep. 12, 2024. The entire contents of each application are hereby incorporated herein by reference.

### BACKGROUND OF THE INVENTION

### 1. Field of the Invention

The present invention relates to energy storage apparatuses.

### 2. Description of the Related Art

Japanese Unexamined Patent Application Publication No. 2020-98697 discloses a battery pack in which a case cover has an opening closed by a maintenance lid, and removing the maintenance lid during maintenance allows access through the opening to an electrical connecting portion that electrically connects a battery module and a bus bar unit.

### SUMMARY OF THE INVENTION

In Japanese Unexamined Patent Application Publication No. 2020-98697, in order to create a configuration that allows access to the electrical connecting portion, an opening is formed in the case cover and a maintenance lid closing the opening is provided. However, it is desired to simplify such a configuration.

Example embodiments of the present invention provide energy storage apparatuses that each allow access to a connecting portion connecting at least two elements in a case with a simple configuration.

An energy storage apparatus according to an example embodiment of the present invention includes an energy storage device, a case that accommodates the energy storage device and that includes a through hole and a connecting portion that is positioned in the case to connects at least two elements in the case, wherein the through hole allows ventilation between an inside and an outside of the case, and at least a portion of the connecting portion is located in the through hole when viewed from a penetration direction of the through hole.

According to the energy storage apparatuses of example embodiments of the present invention, it is possible to access the connecting portion that connects at least two elements in the case with a simple configuration.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating an outer appearance of an energy storage apparatus according to an example embodiment of the present invention.

FIG. 2 is a perspective view illustrating a configuration when an outer case is removed from an energy storage apparatus according to an example embodiment of the present invention.

FIG. 3 is an exploded perspective view illustrating respective elements when an energy storage apparatus (excluding the outer case) according to an example embodiment is exploded.

FIG. 4 is a cross-sectional view illustrating a connection configuration and an arrangement position of a connecting portion according to an example embodiment of the present invention.

FIGS. 5A and 5B include a cross-sectional view and a front view illustrating, in an enlarged manner, the connection configuration and the arrangement position of the connecting portion according to an example embodiment of the present invention.

FIG. 6 is a cross-sectional view illustrating a connection configuration and an arrangement position of a connecting portion included in an energy storage apparatus according to Modification Example 1 of an example embodiment of the present invention.

FIGS. 7A and 7B is a cross-sectional view and a front view illustrating a connection configuration and an arrangement position of a connecting portion included in an energy storage apparatus according to Modification Example 2 of an example embodiment of the present invention.

FIG. 8 is an exploded perspective view illustrating respective elements when a configuration inside an outer case of an energy storage apparatus according to Modification Example 2 of an example embodiment is exploded.

### DETAILED DESCRIPTION OF THE EXAMPLE EMBODIMENTS

(1) An energy storage apparatus according to an example embodiment of the present invention includes an energy storage device, a case that accommodates the energy storage device and that includes a through hole, and a connecting portion that is positioned in the case to connect at least two elements in the case, wherein the through hole allows ventilation between an inside and an outside of the case, and at least a portion of the connecting portion is located in the through hole when viewed from a penetration direction of the through hole.

According to this, the energy storage apparatus is configured to allow ventilation between the inside and the outside of the case via the through hole of the case, and at least a portion of the connecting portion that connects the at least two elements in the case is located in the through hole when viewed from the penetration direction of the through hole. Accordingly, by using the through hole enabling ventilation between the inside and the outside of the case, the connecting portion can be accessed through the through hole. Therefore, according to the energy storage apparatus, it is possible to access the connecting portion that connects the at least two elements in the case with a simple configuration.

(2) In the energy storage apparatus described in the above (1), the connecting portion may include a shaft portion extending in the penetration direction of the through hole.

According to the energy storage apparatus described in the above (2), by accessing the connecting portion through the through hole of the case, the at least two elements in the case can be connected by the shaft portion.

(3) In the energy storage apparatus described in the above (1) or (2), the case may include a vent pipe including the through hole.

According to the energy storage apparatus described in the above (3), by using the through hole of the vent pipe included in the case, the connecting portion can be accessed through the through hole.

(4) In the energy storage apparatus described in any one of the above (1) to (3), the case may include a membrane that covers the through hole and that has air permeability.

According to the energy storage apparatus described in the above (4), by using the through hole in which the membrane is disposed, the connecting portion can be accessed through the through hole.

(5) In the energy storage apparatus described in the above (4), the membrane may be attached to an outer surface of the case around the through hole.

According to the energy storage apparatus described in the above (5), the energy storage apparatus can be easily manufactured by accessing the connecting portion through the through hole of the case to connect the at least two elements in the case, and thereafter attaching the membrane to the outer surface of the case.

Hereinafter, energy storage apparatuses according to example embodiments of the present invention (including modification examples thereof) will be described with reference to the drawings. Each of the example embodiments described below illustrates either a comprehensive example or a specific example. A numerical value, a shape, a material, a element, a position of arrangement and a form of connection of the elements, a manufacturing process, an order of the manufacturing processes, and the like, which are described in the following example embodiments, are merely examples, and are not intended to limit the present invention. In each of the drawings, dimensions and the like are not strictly illustrated. In the drawings, identical or similar elements are assigned the same reference numerals.

In the following description and drawings, a direction in which a pair of (positive and negative) external terminals are arranged, a direction in which a pair of (positive and negative) terminals of one energy storage device are arranged, or an opposing direction of short side surfaces of a container of one energy storage device is defined as an X-axis direction. A penetration direction of a through hole of an outer case, a direction in which the energy storage device and a bus bar are arranged, a direction in which the energy storage device and a circuit board are arranged, a protruding direction of the terminal of the energy storage device, or a direction in which a main body and a lid portion of the container of the energy storage device are arranged is defined as a Y-axis direction. A direction in which a main body and a lid body of the outer case of the energy storage apparatus are arranged, an arrangement direction of a plurality of energy storage devices, an opposing direction of long side surfaces of the container of one energy storage device, or an up-down direction is defined as a Z-axis direction. The X-axis direction, the Y-axis direction, and the Z-axis direction are directions intersecting each other (orthogonal to each other in the present example embodiment). Although there may be a case where the Z-axis direction does not coincide with the up-down direction depending on a usage mode, the Z-axis direction is described as the up-down direction hereinafter for convenience of description.

In the following description, an X-axis positive direction indicates a direction of an arrow in the X-axis, and an X-axis negative direction indicates a direction opposite to the X-axis positive direction. When simply referred to as the X-axis direction, it indicates both or one of the X-axis positive direction and the X-axis negative direction. When referred to as one side and the other side in the X-axis direction, it indicates one and the other of the X-axis positive direction and the X-axis negative direction. The same applies to the Y-axis direction and the Z-axis direction. Expressions indicating relative directions or orientations, such as parallel and orthogonal, include cases where the directions or orientations are not parallel or orthogonal in a strict sense. Two directions being parallel to each other means not only that the two directions are completely parallel to each other, but also that the two directions are substantially parallel to each other, that is, a difference of several percent, for example, is included. In the following description, when the expression “insulation/insulating” is used, “insulation/insulating” is intended as “electrical insulation”. A material having an insulating property is preferably formed of a material having a volume resistivity of 1 ×10¹⁰ Ωm or more.

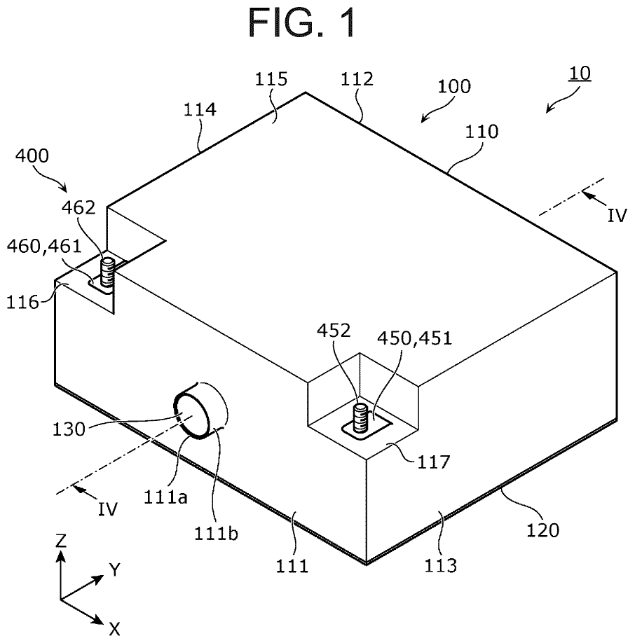

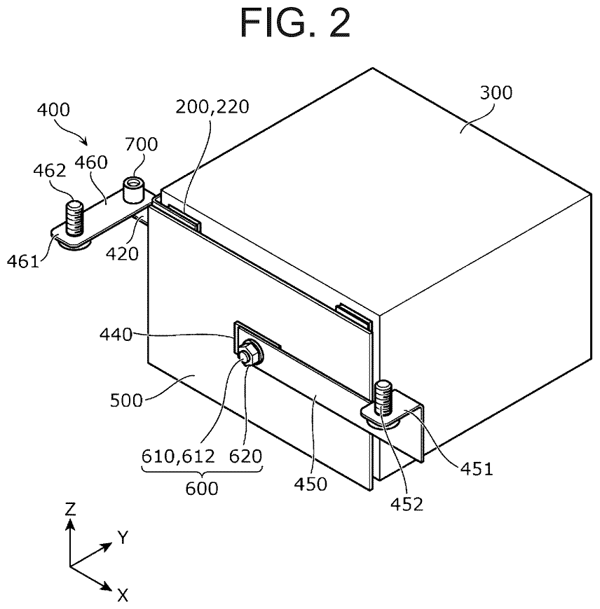

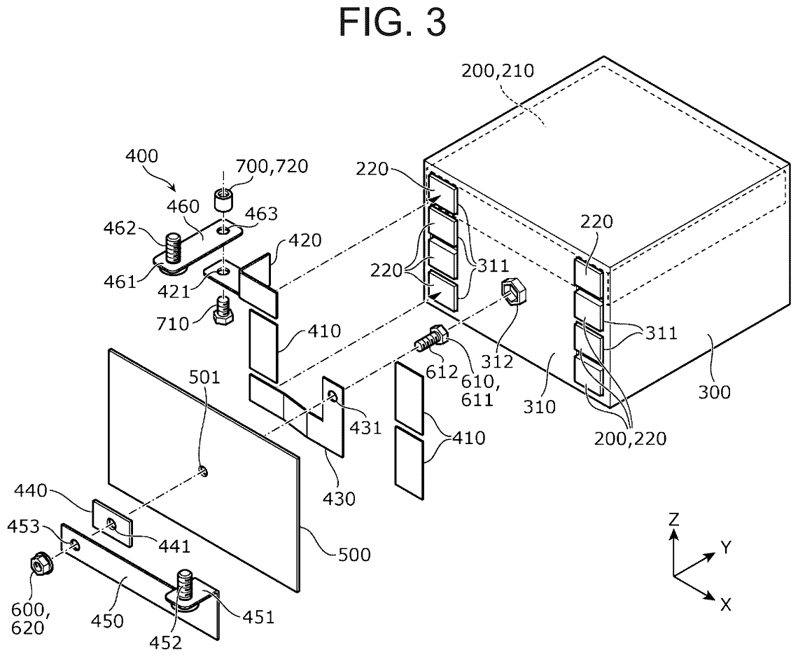

First, a general description of an energy storage apparatus 10 in the present example embodiment will be given. FIG. 1 is a perspective view illustrating an outer appearance of the energy storage apparatus 10 according to the present example embodiment. FIG. 2 is a perspective view illustrating a configuration when an outer case 100 is removed from the energy storage apparatus 10 according to the present example embodiment. In the present example embodiment, bus bars 400 (450, 460) are integrally molded (insert-molded) with the outer case 100; however, FIG. 2 illustrates a state where only the outer case 100 is removed from the energy storage apparatus 10. FIG. 3 is an exploded perspective view illustrating respective elements when the energy storage apparatus 10 (excluding the outer case 100) according to the present example embodiment is exploded. FIG. 3 illustrates respective elements when the configuration illustrated in FIG. 2 is exploded.

The energy storage apparatus 10 is an apparatus which can be charged with electricity from outside and can discharge electricity to outside, and has a substantially rectangular parallelepiped shape in the present example embodiment. The energy storage apparatus 10 is, for example, a battery module (an assembled battery) used for an electric energy storage purpose or a power supply purpose. Specifically, the energy storage apparatus 10 is used as a battery or the like for driving or for engine starting of a mobile object such as an automobile, a motorcycle, a watercraft, a ship, a snowmobile, an agricultural machine, a construction machine, an automated guided vehicle (AGV), or a railway vehicle for electric railway. As the above-mentioned automobiles, electric vehicles (EVs), hybrid electric vehicles (HEVs), plug-in hybrid electric vehicles (PHEVs), and fossil fuel (gasoline, light oil, liquefied natural gas, etc.) automobiles are exemplified. As the above-mentioned railway vehicles for electric railway, trains, monorails, magnetic levitation trains, and hybrid trains provided with both a diesel engine and an electric motor are exemplified. The energy storage apparatus 10 can also be used as a stationary battery for home or business use, or the like.

As illustrated in FIGS. 1 to 3, the energy storage apparatus 10 includes the outer case 100, a plurality of energy storage devices 200, an inner case 300, the bus bars 400 (410 to 460), a circuit board 500, and a connecting portion 600. In addition to the above elements, the energy storage apparatus 10 may include a spacer disposed between the plurality of energy storage devices 200, a restraint (a side plate, an end plate, etc.) restraining the plurality of energy storage devices 200, a bus bar holder holding the bus bars 400, and the like.

The outer case 100 is a container (module case) having a substantially rectangular parallelepiped shape (box shape), which constitutes an exterior (enclosure, outer shell) of the energy storage apparatus 10. The outer case 100 is disposed outward of the plurality of energy storage devices 200, the inner case 300, the bus bars 400 (410 to 440), the circuit board 500, the connecting portion 600, and the like, and accommodates the energy storage devices 200 and the like. The outer case 100 fixes these energy storage devices 200 and the like at predetermined positions and protects them from impact and the like. The outer case 100 includes a case main body 110 constituting a main body of the outer case 100, a case lid body 120 constituting a lid body of the outer case 100, and a membrane 130. The case main body 110 and the case lid body 120 are joined (sealed) by adhesive, heat sealing, ultrasonic welding, screwing with bolts, or the like. Accordingly, the outer case 100 is configured such that ventilation between the inside and the outside of the outer case 100 is not allowed at any locations other than the membrane 130.

The case main body 110 and the case lid body 120 of the outer case 100 are formed of an insulator or the like such as polycarbonate (PC), polypropylene (PP), polyethylene (PE), polystyrene (PS), polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), ABS resin, or a composite material thereof. The outer case 100 thereby avoids contact of the energy storage devices 200 and the like with external metal structures or the like. The case main body 110 and the case lid body 120 may be formed of the same material, or may be formed of different materials. At least one of the case main body 110 and the case lid body 120 may be formed of a metal as long as the insulation of the energy storage devices 200 and the like is secured.

The case main body 110 is a housing (enclosure) having a bottomed rectangular tubular shape with an opening formed in the Z-axis negative direction, and accommodates the energy storage devices 200 and the like. The case main body 110 includes outer case side walls 111 and 112 which are a pair of flat plate-shaped long side walls on both sides in the Y-axis direction, includes outer case side walls 113 and 114 which are a pair of flat plate-shaped short side walls on both sides in the X-axis direction, and includes an outer case upper wall 115 which is a flat plate-shaped upper wall in the Z-axis positive direction. The outer case side wall 111 is disposed at an end portion of the case main body 110 in the Y-axis negative direction, and is a wall facing the Y-axis negative direction. The outer case side wall 112 is disposed at an end portion of the case main body 110 in the Y-axis positive direction, and is a wall facing the Y-axis positive direction. The outer case side wall 113 is disposed at an end portion of the case main body 110 in the X-axis positive direction, and is a wall facing the Y-axis positive direction. The outer case side wall 114 is disposed at an end portion of the case main body 110 in the Y-axis negative direction, and is a wall facing the Y-axis negative direction. The outer case upper wall 115 is disposed at an end portion of the case main body 110 in the Z-axis positive direction, and is a wall facing the Z-axis positive direction. Depending on the configuration (number, size, shape, etc.) of the contents of the outer case 100, the case main body 110 (outer case side walls 111 to 114, outer case upper wall 115) may have any shape. In this case, the outer case side walls 111 and 112 may be short side walls, and the outer case side walls 113 and 114 may be long side walls.

A case recess 116 is formed in the case main body 110 by recessing a corner located at the Y-axis negative direction end portion and the X-axis negative direction end portion, and a case recess 117 is formed by recessing a corner located at the Y-axis negative direction end portion and the X-axis positive direction end portion. External terminal portions 461 and 462 of the bus bar 460 described below are exposed from the case recess 116, and external terminal portions 451 and 452 of the bus bar 450 described below are exposed from the case recess 117. Specifically, the external terminal portions 461 and 462 are integrally molded (insert-molded) with the case main body 110 in the case recess 116, whereby the case main body 110 and the external terminal portions 461 and 462 are integrated in a state where the external terminal portions 461 and 462 are exposed from the case recess 116. The external terminal portions 451 and 452 are integrally molded (insert-molded) with the case main body 110 in the case recess 117, whereby the case main body 110 and the external terminal portions 451 and 452 are integrated in a state where the external terminal portions 451 and 452 are exposed from the case recess 117. The case main body 110 and the external terminal portions 461 and 462 may be integrated (integrally molded) by a method other than insert molding, or may not be integrated (integrally molded). The same applies to the case main body 110 and the external terminal portions 451 and 452.

The outer case side wall 111 of the case main body 110 includes a through hole 111a. The through hole 111a is a circular through hole when viewed from the Y-axis direction, penetrating the outer case side wall 111 in the Y-axis direction. In the present example embodiment, the outer case side wall 111 includes a vent pipe 111b, and the through hole 111a is an opening formed in the vent pipe 111b. That is, the outer case side wall 111 includes the vent pipe 111b including the through hole 111a. The vent pipe 111b is a tubular (cylindrical) pipe that protrudes in the Y-axis negative direction from an outer wall surface of the outer case side wall 111 in the Y-axis negative direction and extends in the Y-axis negative direction. The vent pipe 111b is an exhaust pipe for discharging gas to the outside of the outer case 100 (outside of the energy storage apparatus 10) when the gas is discharged from the energy storage device 200. A pipe (not illustrated) such as a gas hose is connectable to the vent pipe 111b. In the present example embodiment, the vent pipe 111b is provided at the X-axis direction central portion and the Z-axis direction central portion of the outer case side wall 111. Although the vent pipe 111b is formed integrally with other parts of the case main body 110, it may be configured as a separate body from the other parts. Thus, the outer case 100 includes the through hole 111a (includes the vent pipe 111b including the through hole 111a). The outer case 100 is an example of a case including a through hole.

The case lid body 120 is a flat rectangular structure that closes the opening of the case main body 110 in the Z-axis negative direction. In the present example embodiment, the case lid body 120 is a flat plate-shaped structure defining a bottom wall of the outer case 100, and is disposed in the Z-axis negative direction of the case main body 110. The case lid body 120 may be a structure or the like having a bottomed rectangular tubular shape with an opening formed in the Z-axis positive direction. The case main body 110 may be a structure having a bottomed rectangular tubular shape with an opening formed in the Z-axis positive direction, and the case lid body 120 may be a structure closing the opening.

The membrane 130 is a membrane that covers the through hole 111a of the case main body 110 and that has air permeability. In other words, the membrane 130 covers (closes) the through hole 111a while allowing ventilation. That is, the membrane 130 covers the entire through hole 111a, but does not completely stop (block) the flow of gas passing through the through hole 111a. Specifically, the membrane 130 has air permeability to an extent that pressure equilibrium between the outside and the inside of the outer case 100 in a normal state can be realized. When gas is discharged from the energy storage device 200 and the internal pressure of the outer case 100 becomes excessively large, the membrane 130 breaks and/or moves (peels off) so as to open the through hole 111a. Accordingly, the gas inside the outer case 100 is discharged to the outside of the outer case 100 via the through hole 111a. Thus, the through hole 111a is not closed by a lid that does not allow ventilation, and the energy storage apparatus 10 is configured to allow ventilation between the inside and the outside of the outer case 100 via the through hole 111a. Specifically, the energy storage apparatus 10 is configured to allow ventilation from the inside to the outside of the outer case 100 and from the outside to the inside thereof via the through hole 111a and the membrane 130.

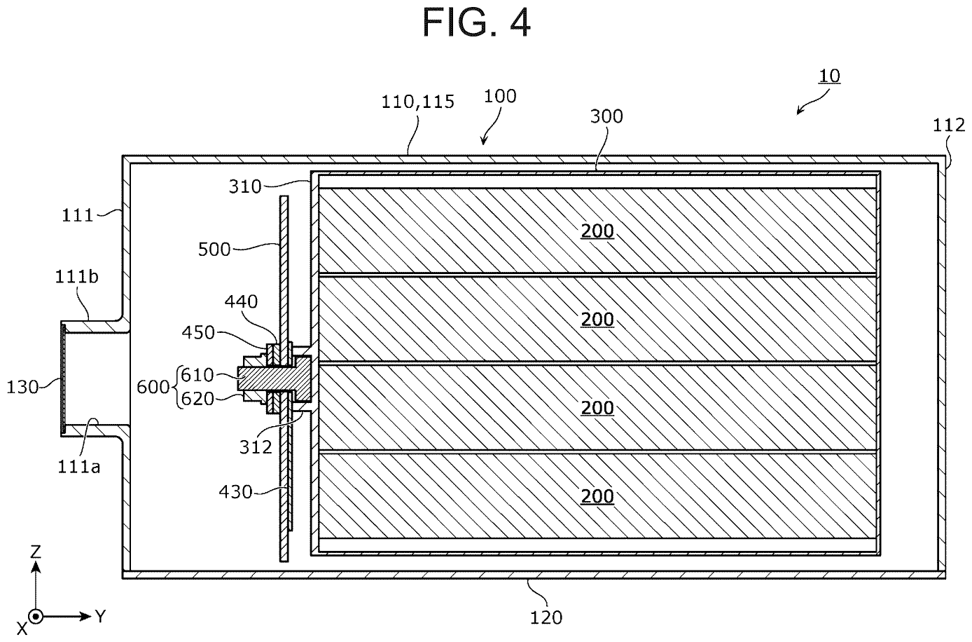

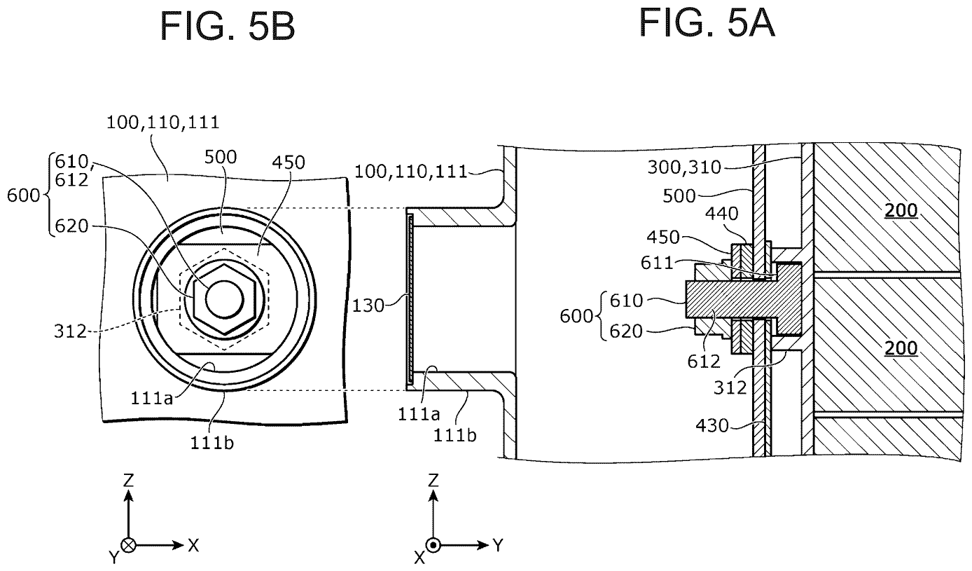

The membrane 130 is attached to an outer surface of the outer case 100 around the through hole 111a. Specifically, the membrane 130 is disposed at a tip portion (an end portion in the Y-axis negative direction) of the vent pipe 111b, and is attached to an outer surface (a surface in the Y-axis negative direction) of the tip portion. In the present example embodiment, the tip portion of the vent pipe 111b is recessed and the membrane 130 is attached to the recessed portion (see FIGS. 4 and 5), but the membrane 130 may be attached to the outer surface (the end surface in the Y-axis negative direction) of the tip portion without the tip portion of the vent pipe 111b being recessed. The membrane 130 is joined to the vent pipe 111b by welding such as thermal welding, laser welding, or ultrasonic welding, or by adhesion using an adhesive, a double-sided tape, or the like.

In the present example embodiment, the membrane 130 is an air-permeable waterproof membrane made of a material having air permeability and waterproofness. As a material forming the membrane 130, Gore-Tex (registered trademark), TEMISH (registered trademark), C-Porous (registered trademark), Porum (registered trademark), NF Sheet (registered trademark), a porous film made from PTFE, a porous film composite product made from PTFE and PET, a porous film made from PE, a porous film made from PP, or the like is adopted. The membrane 130 suppresses intrusion of foreign matter such as water into the inside of the outer case 100 via the vent pipe 111b. The membrane 130 only needs to have air permeability, and may be formed from a material having no waterproofness, such as a nonwoven fabric made from PET.

The energy storage device 200 is a secondary battery (single cell) capable of charging electricity and discharging electricity, and more specifically, is a non-aqueous electrolyte secondary battery such as a lithium-ion secondary battery. The energy storage device 200 has a rectangular parallelepiped shape (prismatic shape or box shape) flattened in the Z-axis direction, and in the present example embodiment, four energy storage devices 200 are arranged in the Z-axis direction. The size and shape of the energy storage device 200, the number of energy storage devices 200 arranged, and the like are not limited, and for example, the energy storage device 200 may have a columnar shape (cylindrical shape), an elongated columnar shape, an elliptical columnar shape, a polygonal columnar shape other than a rectangular parallelepiped shape, or the like, or only one energy storage device 200 may be disposed. The energy storage device 200 is not limited to a non-aqueous electrolyte secondary battery, and may be a secondary battery other than a non-aqueous electrolyte secondary battery, or may be a capacitor. The energy storage device 200 may be a primary battery instead of a secondary battery. The energy storage device 200 may be a battery using a solid electrolyte. The energy storage device 200 may be a pouch-type energy storage device.

The energy storage device 200 includes a container 210 and a pair of (positive and negative) terminals 220. An electrode body, a pair of (positive and negative) current collectors, an electrolyte solution (non-aqueous electrolyte), and the like are accommodated inside the container 210, and a gasket is disposed between the container 210 and both the terminal 220 and the current collector, but illustration thereof is omitted. The type of the electrolyte solution is not particularly limited as long as it does not impair the performance of the energy storage device 200, and various types can be selected. In addition to the above elements, the energy storage device 200 may include a spacer disposed laterally or downward of the electrode body, an insulating film wrapping the electrode body or the like, or an insulating film (shrink tube, etc.) covering the outer surface of the container 210.

The container 210 is a rectangular parallelepiped-shaped container (prismatic shape or box shape) including a container main body having an opening formed therein and a container lid portion closing the opening of the container main body. The container main body has a pair of long side surfaces on both side surfaces in the Z-axis direction, has a pair of short side surfaces on both side surfaces in the X-axis direction, has a bottom surface in the Y-axis positive direction, and has the container lid portion disposed in the Y-axis negative direction. The container lid portion is provided with a gas discharge valve (not illustrated) that releases pressure inside the container 210 when the pressure rises excessively, a liquid injection portion (not illustrated) for injecting the electrolyte solution into the container 210, and the like. The material of the container 210 is not particularly limited, and may be a weldable metal such as stainless steel, aluminum, aluminum alloy, iron, or plated steel plate, or may be a resin.

The terminals 220 are electrode terminals (positive and negative electrode terminals) of the energy storage device 200, which are disposed on the container lid portion of the container 210. The terminals 220 are disposed so as to protrude from the container 210 in the Y-axis negative direction. The terminals 220 are electrically connected to a positive electrode plate and a negative electrode plate of the electrode body via the current collector. The terminal 220 is formed of aluminum, an aluminum alloy, copper, a copper alloy, or the like.

The electrode body is an energy storage element (power generating element) formed by stacking a positive electrode plate, a negative electrode plate, and a separator. The positive electrode plate is formed by forming a positive active material layer on a current collecting foil made of metal such as aluminum or an aluminum alloy. The negative electrode plate is formed by forming a negative active material layer on a current collecting foil made of metal such as copper or a copper alloy. As the active material used for the positive active material layer and the negative active material layer, known materials can be used as appropriate as long as they can absorb and release lithium ions. As the separator, a microporous sheet or nonwoven fabric made of resin can be used. In the present example embodiment, the electrode body is formed by stacking electrode plates (a positive electrode plate and a negative electrode plate) in the Z-axis direction. The electrode body may be of any form, such as a wound type electrode body formed by winding electrode plates (a positive electrode plate and a negative electrode plate), a stacked type (stack type) electrode body formed by stacking a plurality of flat plate-shaped electrode plates, or a bellows type electrode body formed by folding electrode plates in a bellows shape.

The current collector is a conductive current collector (positive and negative electrode current collectors) electrically connected to the terminal 220 and the electrode body. The positive electrode current collector is formed of aluminum, an aluminum alloy, or the like, similarly to the current collecting foil of the positive electrode plate of the electrode body, and the negative electrode current collector is formed of copper, a copper alloy, or the like, similarly to the current collecting foil of the negative electrode plate of the electrode body. The gasket is disposed between the container lid portion and both the terminal 220 and the current collector, and insulates between the container lid portion and both the terminal 220 and the current collector. The gasket may be formed of any material as long as it has insulating properties.

The inner case 300 is a container having a substantially rectangular parallelepiped shape (box shape) constituting an inner box of the energy storage apparatus 10. The inner case 300 accommodates the plurality of energy storage devices 200 and fixes the plurality of energy storage devices 200 at predetermined positions. The inner case 300 is formed of any material usable for the case main body 110 and the case lid body 120 of the outer case 100.

Specifically, the inner case 300 includes six flat plate-shaped and rectangular wall portions disposed on both sides in the X-axis direction, both sides in the Y-axis direction, and both sides in the Z-axis direction of the plurality of energy storage devices 200. Among the six wall portions, a wall portion located in the Y-axis negative direction of the plurality of energy storage devices 200 is referred to as an inner case wall portion 310. The inner case wall portion 310 is provided with openings 311 into which the terminals 220 of the energy storage devices 200 are inserted, a connecting portion 312 to which the connecting portion 600 is connected, and an opening (not illustrated) through which gas discharged from the energy storage devices 200 passes.

The opening 311 is a through hole through which the terminal 220 of the energy storage device 200 penetrates, and a plurality of openings 311 (five openings 311 in the present example embodiment) are provided so that all terminals 220 included in the plurality of energy storage devices 200 can penetrate therethrough. The terminal 220 penetrates the opening 311 and protrudes from the inner case wall portion 310 in the Y-axis negative direction. Accordingly, all terminals 220 included in the plurality of energy storage devices 200 are disposed so as to protrude from the inner case 300 via the openings 311. The number, size, shape, and the like of the openings 311 are not particularly limited.

The connecting portion 312 is a portion to which a head portion 611 of a bolt 610 included in the connecting portion 600 described below is connected. The connecting portion 312 is a protruding portion disposed at the X-axis direction central portion and the Z-axis direction central portion of the inner case wall portion 310 and protruding in the Y-axis negative direction. The connecting portion 312 has a recess formed therein and having a hexagonal shape when viewed from the Y-axis direction, and the head portion 611 included in the bolt 610 and having a hexagonal shape when viewed from the Y-axis direction is inserted (fitted) into the recess. Accordingly, the bolt 610 is connected (fixed) to the connecting portion 312, and rotation around the axial direction (the Y-axis direction) of the bolt 610 is restricted. Thus, the connecting portion 312 has a function of fixing the connecting portion 600 (the bolt 610), with the connecting portion 600 (the bolt 610) being connected thereto, and preventing rotation of the connecting portion 600 (the bolt 610).

The bus bar 400 is a plate-shaped structure electrically connected to the energy storage device 200. The bus bar 400 is formed of a conductive material made of metal such as aluminum, an aluminum alloy, copper, a copper alloy, or nickel, or a combination thereof, or a material having conductivity other than metal, or the like. The bus bar 400 includes three bus bars 410, a bus bar 420, a bus bar 430, a bus bar 440, a bus bar 450, and a bus bar 460.

The bus bars 410 to 430 are disposed in the Y-axis negative direction of the plurality of energy storage devices 200 and the inner case 300, and in the Y-axis positive direction of the circuit board 500. The bus bars 410 to 430 are connected (joined) to the plurality of energy storage devices 200. The bus bar 420 is connected to the bus bar 460. The bus bar 430 is electrically connected to the bus bars 440 and 450 via the circuit board 500. Specifically, the bus bars 410 to 430 electrically connect the terminals 220 of the plurality of energy storage devices 200 to each other, electrically connect the terminal 220 of the energy storage device 200 at one end portion and the bus bars 440 and 450, and electrically connect the terminal 220 of the energy storage device 200 at the other end portion and the bus bar 460.

The three bus bars 410 are connected (joined) to the terminals 220 of four energy storage devices 200 to connect the four energy storage devices 200 in series. The bus bar 420 is connected (joined) to the terminal 220 in the X-axis negative direction of the energy storage device 200 at the end portion in the Z-axis positive direction. The bus bar 420 is a plate-shaped structure that extends in the X-axis negative direction from a connection portion with the terminal 220, is bent in the Y-axis positive direction to extend in the Y-axis positive direction and the Z-axis negative direction, and is bent in the X-axis negative direction to extend in the X-axis negative direction.

The bus bar 420 is connected (fixed) to the bus bar 460 by a connecting portion 700. In the present example embodiment, the connecting portion 700 includes a bolt 710 and a nut 720. The bolt 710 is a bolt (hexagon bolt) including a shaft portion (shaft body) extending in the Z-axis direction, in which a male screw portion is formed. The nut 720 is a cylindrical nut including a female screw portion to which the male screw portion of the bolt 710 is coupled. The bolt 710 is inserted into a through hole 421 formed in the bus bar 420 and a through hole 463 formed in the bus bar 460, and is coupled with the nut 720. The nut 720 is fixed to the case main body 110 of the outer case 100 by insert molding or the like. In the present example embodiment, the nut 720 has a circular outer shape when viewed from the Z-axis direction, but may have a non-circular outer shape such as a polygonal shape including a hexagon, an elliptical shape, or an oblong shape for stopping rotation with respect to the case main body 110 at the time of coupling with the bolt 710. Accordingly, the connecting portion 700 connects (joins) the bus bar 420 to the bus bar 460.

The bus bar 430 is connected (joined) to the terminal 220 in the X-axis negative direction of the energy storage device 200 at the end portion in the Z-axis negative direction. The bus bar 430 contacts the circuit board 500 and is electrically connected to the circuit board 500 (electrically connected to an electric component included in the circuit board 500), whereby it is electrically connected to the bus bars 440 and 450 via the circuit board 500. The bus bar 430 is fixed to the circuit board 500 by the connecting portion 600. The connection form of the bus bars 410 to 430 is not particularly limited, and any of the energy storage devices 200 may be connected in parallel. In the present example embodiment, the bus bars 410 to 430 are joined to the terminals 220 by welding, but the terminals 220 may be bolt terminals having bolt portions (male screw portions) and bolted to the terminals 220, or may be joined by other methods.

The bus bars 440 and 450 are electrically connected to the plurality of energy storage devices 200 via the bus bars 410 to 430 and the circuit board 500. The bus bars 440 and 450 are disposed at positions sandwiching the circuit board 500 with the bus bars 410 to 430. The bus bar 440 is disposed in the Y-axis negative direction of the circuit board 500, and the bus bar 450 is disposed in the Y-axis negative direction of the bus bar 440. The bus bar 440 contacts the circuit board 500 and is electrically connected to the circuit board 500 (electrically connected to an electric component included in the circuit board 500). The bus bar 450 contacts the bus bar 440 and is electrically connected to the bus bar 440. Accordingly, the bus bar 450 is electrically connected to the circuit board 500 (electrically connected to an electric component included in the circuit board 500). The bus bars 440 and 450 are fixed to the circuit board 500 by the connecting portion 600.

With such a configuration, the bus bar 460 is connected to the bus bar 430 via the bus bar 420, the plurality of energy storage devices 200, and the bus bar 410, the bus bar 430 is connected to the circuit board 500, the circuit board 500 is connected to the bus bar 440, and the bus bar 440 is connected to the bus bar 450. The bus bar 460 and the bus bar 450 are partially exposed from the outer case 100 and connected to an external conductive structure (not illustrated).

Specifically, the bus bar 460 includes external terminal portions 461 and 462 having one of a positive external terminal function and a negative external terminal function, and the bus bar 450 includes external terminal portions 451 and 452 having the other of the positive external terminal function and the negative external terminal function. The external terminal portion 461 is fixed to the case main body 110 in a state of being exposed from the case recess 116 of the case main body 110, and is a portion connected to (contacted with) the external conductive structure. The external terminal portion 462 connects (fixes) the external terminal portion 461 and the external conductive structure. In the present example embodiment, the external terminal portion 462 includes a male screw portion, and connects (fixes) the external terminal portion 461 and the external conductive structure by being coupled with a nut (not illustrated). The external terminal portion 462 may be formed of any material usable for the bus bar 400 described above, or may be formed of a metal such as stainless steel or iron, or a material having high strength other than metal. Since the configurations of the external terminal portions 451 and 452 are the same as the configurations of the external terminal portions 461 and 462, detailed description thereof is omitted. The energy storage apparatus 10 is charged with electricity from the outside and discharges electricity to the outside via the bus bar 460 (external terminal portion 461) and the bus bar 450 (external terminal portion 451).

The circuit board 500 is a circuit board that is electrically connected to the energy storage devices 200 to monitor a charge state or a discharge state of the energy storage devices 200 or control charging and discharging of the energy storage devices 200. The circuit board 500 is a flat plate-shaped and rectangular structure parallel to the XZ plane. The circuit board 500 includes electric components (all not illustrated) such as a fuse, a relay, a semiconductor switch such as a Field Effect Transistor (FET), a shunt resistor, a thermistor, and a connector. By acquiring information such as the voltage of the energy storage devices 200 via the bus bars 400, a cable (not illustrated), or the like, the circuit board 500 monitors states such as the charge state and the discharge state of the energy storage devices 200, or controls charging and discharging of the energy storage devices 200. The circuit board 500 may control charging and discharging of the energy storage devices 200 by acquiring temperature information of the energy storage devices 200 via a thermistor (not illustrated). The circuit board 500 may only monitor the state of the energy storage devices 200 without controlling charging and discharging of the energy storage devices 200.

The circuit board 500 is disposed between the bus bars 410 to 430 and the bus bars 440 and 450, and is electrically connected to the bus bars 410 to 430 and the bus bars 440 and 450. The circuit board 500 is fixed to the bus bar 430 and the bus bars 440 and 450 by the connecting portion 600 between the bus bar 430 and the bus bars 440 and 450. Specifically, in a state where the circuit board 500 is fixed to the bus bar 430 and the bus bars 440 and 450, the circuit board 500 is fixed to the inner case 300 by the connecting portion 600 and supported by the inner case 300.

The connecting portion 600 is disposed in the outer case 100 and connects at least two elements in the outer case 100. The at least two elements in the outer case 100 may be any two or more elements at least partially disposed in the outer case 100, and include the bus bar 450 or the like, a portion of which (external terminal portions 451 and 452) is exposed from the outer case 100. In the present example embodiment, the connecting portion 600 connects the inner case 300, the bus bar 430, the circuit board 500, the bus bar 440, and the bus bar 450. That is, the connecting portion 600 connects at least two elements among the inner case 300, the bus bar 430, the circuit board 500, the bus bar 440, and the bus bar 450. It can also be said that the connecting portion 600 connects at least two elements included in the energy storage apparatus 10.

The connecting portion 600 includes a bolt 610 and a nut 620. The bolt 610 is a bolt including a head portion 611 and a shaft portion 612. The head portion 611 is a portion disposed at an end portion of the bolt 610 in the Y-axis positive direction, and having a hexagonal shape when viewed from the Y-axis direction and a hexagonal columnar shape flattened in the Y-axis direction. The shaft portion 612 is a shaft body extending in the Y-axis negative direction from the head portion 611 and including a male screw portion. The nut 620 is a nut including a female screw portion to which the male screw portion of the shaft portion 612 of the bolt 610 is coupled. The connecting portion 600 connects (joins) the inner case 300, the bus bar 430, the circuit board 500, the bus bar 440, and the bus bar 450 by fixing the bolt 610 to the connecting portion 312 of the inner case 300 and coupling the bolt 610 with the nut 620. A configuration in which the connecting portions 600 and 312 connect (join) these elements will be described in detail below with reference to FIGS. 4 and 5 as well.

FIG. 4 is a cross-sectional view illustrating a connection configuration and an arrangement position of the connecting portions 600 and 312 according to the present example embodiment. FIG. 4 illustrates a cross section when the energy storage apparatus 10 illustrated in FIG. 1 is cut along a plane parallel to the YZ plane passing through line IV-IV. FIGS. 5A and 5B includes a cross-sectional view and a front view illustrating, in an enlarged manner, the connection configuration and the arrangement position of the connecting portions 600 and 312 according to the present example embodiment. FIG. 5A is a cross-sectional view illustrating the connecting portions 600 and 312 and the periphery thereof illustrated in FIG. 4 in an enlarged manner, and FIG. 5B is a front view illustrating a configuration when FIG. 5A is viewed from the front (the Y-axis negative direction). In FIG. 5B, illustration of the membrane 130 is omitted.

As illustrated in FIGS. 4 and 5, the head portion 611 of the bolt 610 of the connecting portion 600 is inserted into the connecting portion 312 of the inner case wall portion 310 of the inner case 300, and is connected (fixed) to the connecting portion 312. In this state, the shaft portion 612 of the bolt 610 penetrates the bus bar 430, the circuit board 500, the bus bar 440, and the bus bar 450. Then, an end portion of the shaft portion 612 in the Y-axis negative direction is coupled with the nut 620.

Specifically, as illustrated in FIG. 3, a through hole 431 is formed at a position overlapping with the shaft portion 612 in the bus bar 430 when viewed from the Y-axis direction. The through hole 431 is a circular through hole having a size larger than the shaft portion 612 when viewed from the Y-axis direction, formed at the X-axis positive direction end portion and the Z-axis positive direction end portion of the bus bar 430. A through hole 501 is formed at a position overlapping with the shaft portion 612 in the circuit board 500 when viewed from the Y-axis direction. The through hole 501 is a circular through hole having a size larger than the shaft portion 612 when viewed from the Y-axis direction, formed at the X-axis direction central portion and the Z-axis direction central portion of the circuit board 500. A through hole 441 is formed at a position overlapping with the shaft portion 612 in the bus bar 440 when viewed from the Y-axis direction. The through hole 441 is a circular through hole having a size larger than the shaft portion 612 when viewed from the Y-axis direction, formed at the X-axis direction central portion and the Z-axis direction central portion of the bus bar 440. A through hole 453 is formed at a position overlapping with the shaft portion 612 in the bus bar 450 when viewed from the Y-axis direction. The through hole 453 is a circular through hole having a size larger than the shaft portion 612 when viewed from the Y-axis direction, formed at the X-axis negative direction end portion of the bus bar 450. The shaft portion 612 is inserted into the through hole 431 of the bus bar 430, the through hole 501 of the circuit board 500, the through hole 441 of the bus bar 440, and the through hole 453 of the bus bar 450, penetrates them in the Y-axis direction, and is coupled with the nut 620.

Accordingly, the connecting portion 600 connects (joins), together with the connecting portion 312, the inner case 300, the bus bar 430, the circuit board 500, the bus bar 440, and the bus bar 450 in this order. With this configuration, elements in the outer case 100, such as the energy storage devices 200, the bus bars 400, and the circuit board 500, are fixed in the outer case 100. Thus, the connecting portion 600 connects at least two elements in the outer case 100 together with the connecting portion 312. That is, in the present example embodiment, the connecting portions 600 and 312 are an example of a connecting portion disposed in the outer case 100 and connecting at least two elements in the outer case 100.

In such a configuration, at least a portion of the connecting portion 600 is disposed in the through hole 111a when viewed from the penetration direction of the through hole 111a. That is, when the membrane 130 is removed from the vent pipe 111b of the outer case 100 and the inside of the through hole 111a is viewed from the penetration direction (Y-axis direction) of the through hole 111a of the vent pipe 111b, at least a portion of the connecting portion 600 is visible. In the present example embodiment, the entire connecting portion 600 (the bolt 610 and the nut 620) is disposed in the through hole 111a when viewed from the penetration direction (the Y-axis direction) of the through hole 111a. Similarly, at least a portion of the connecting portion 312 of the inner case 300 (the whole in the present example embodiment) is disposed in the through hole 111a when viewed from the penetration direction (the Y-axis direction) of the through hole 111a. At least a portion of the through hole 431 of the bus bar 430 (the whole in the present example embodiment) is disposed in the through hole 111a when viewed from the penetration direction (the Y-axis direction) of the through hole 111a. The same applies to the through hole 501 of the circuit board 500, the through hole 441 of the bus bar 440, and the through hole 453 of the bus bar 450.

In the present example embodiment, the shaft portion 612 of the bolt 610 extends in the penetration direction (the Y-axis direction) of the through hole 111a. Specifically, a central axis of the shaft portion 612 and a central axis of the through hole 111a coincide with each other (are coaxial). It can also be said that a central axis of the connecting portion 600 and the central axis of the through hole 111a coincide with each other (are coaxial). That is, the connecting portion 600 (the bolt 610 and the nut 620) is disposed at a central portion (a center position) of the through hole 111a when viewed from the penetration direction (the Y-axis direction) of the through hole 111a. Similarly, a central axis of the connecting portion 312 and the central axis of the through hole 111a coincide with each other (are coaxial), and the connecting portion 312 is disposed at the central portion (the center position) of the through hole 111a when viewed from the penetration direction (the Y-axis direction) of the through hole 111a. A central axis of the through hole 431 of the bus bar 430 and the central axis of the through hole 111a coincide with each other (are coaxial), and the through hole 431 is disposed at the central portion (the center position) of the through hole 111a when viewed from the penetration direction (the Y-axis direction) of the through hole 111a. The same applies to the through hole 501 of the circuit board 500, the through hole 441 of the bus bar 440, and the through hole 453 of the bus bar 450.

As described above, the energy storage apparatus 10 according to the example embodiment of the present invention is configured to allow ventilation between the inside and the outside of the outer case 100 via the through hole 111a of the outer case 100. At least a portion of the connecting portion 600 or 312 connecting at least two elements in the outer case 100 is disposed in the through hole 111a when viewed from the penetration direction of the through hole 111a. Accordingly, by using the through hole 111a enabling ventilation between the inside and the outside of the outer case 100, the connecting portion 600 or 312 can be accessed through the through hole 111a. Therefore, according to the energy storage apparatus 10, it is possible to access the connecting portion 600 or 312 connecting at least two elements in the outer case 100 with a simple configuration.

If the configuration allows access to the connecting portion 600 or 312 through the through hole 111a, a tool (such as a socket or bit for screw or bolt joining) can be inserted into the through hole 111a to allow the tool to access the connecting portion 600 or 312. Therefore, the at least two elements in the outer case 100 can be connected with a simple configuration. By using the through hole 111a enabling ventilation between the inside and the outside of the outer case 100, there is no need to provide a lid closing the through hole 111a, so that the number of parts can be reduced, and a process of attaching a lid to secure airtightness can be made unnecessary. With these, the manufacture of the energy storage apparatus 10 can be facilitated and cost reduction can be achieved. Parts inside the outer case 100, such as the connecting portion 600 or a harness, can also be taken out through the through hole 111a.

The reason for providing the through hole 111a enabling ventilation between the inside and the outside of the outer case 100 (the reason for not closing the through hole 111a with a lid that does not allow ventilation) is as follows. If the strength of the outer case 100 is increased, for example, by making the outer case 100 of metal so that the outer case 100 can withstand internal pressure, problems such as increased cost or increased weight of the outer case 100 arise. Therefore, the outer case 100 is made of resin or the like, and the membrane 130 having air permeability is provided to enable ventilation between the inside and the outside of the outer case 100 in order to equalize the internal pressure and the external pressure of the outer case 100. In a case where the membrane 130 is not provided, since there is a possibility that an unintended portion of the outer case 100 may break due to an excessive rise in internal pressure in the outer case 100, it becomes necessary to design so as to reduce the amount of gas discharged from the energy storage devices 200.

In the present example embodiment, since the bus bar 450 is fixed (insert-molded) to the outer case 100, in order to connect the bus bar 450 to the bus bar 430 or the like in the outer case 100, a manufacturing method in which the bus bar 450 is connected to the bus bar 430 or the like and then disposed in the outer case 100 cannot be adopted. Therefore, the through hole 111a is provided in the outer case 100, and the bus bar 450 is connected to the bus bar 430 or the like by the connecting portions 600 and 312 via the through hole 111a from the outside of the outer case 100. Accordingly, the bus bar 450 can be connected to the bus bar 430 or the like with a simple configuration. That is, when connecting an element fixed to an element separate from the outer case 100 and an element disposed inside the outer case 100 with a large element such as the circuit board 500 interposed therebetween as in the present example embodiment, it is more useful that the energy storage apparatus is configured to allow ventilation between the inside and the outside of the outer case 100 via the through hole 111a.

Regarding the bus bar 460, since it is fixed (insert-molded) to the case main body 110 of the outer case 100 similarly to the bus bar 450, the case lid body 120 is attached to the case main body 110 after being connected (fixed) to the bus bar 420 by the connecting portion 700. The bus bar 460 may be connected to the bus bar 420 by a method similar to that for the bus bar 450. That is, the bus bar 460 may be connected to the bus bar 420 by providing a through hole (not illustrated) in the outer case 100 (the case lid body 120) or the like. In this case, the through hole may be covered with a membrane or closed with a small lid.

The connecting portion 600 (the bolt 610) includes the shaft portion 612 extending in the penetration direction of the through hole 111a. Accordingly, by accessing the connecting portion 600 (the shaft portion 612 and the nut 620) through the through hole 111a of the outer case 100, at least two elements in the outer case 100 can be connected using the shaft portion 612 and the nut 620.

The outer case 100 includes the vent pipe 111b including the through hole 111a. Accordingly, by using the through hole 111a of the vent pipe 111b included in the outer case 100, the connecting portion 600 or 312 can be accessed through the through hole 111a.

The outer case 100 includes the membrane 130 covering the through hole 111a and having air permeability. Accordingly, by using the through hole 111a in which the membrane 130 is disposed, the connecting portion 600 or 312 can be accessed through the through hole 111a.

The membrane 130 is attached to the outer surface of the outer case 100 (the vent pipe 111b) around the through hole 111a. Accordingly, the energy storage apparatus 10 can be easily manufactured by accessing the connecting portion 600 or 312 through the through hole 111a of the outer case 100 to connect the at least two elements in the outer case 100, and thereafter attaching the membrane 130 to the outer surface of the outer case 100 (the vent pipe 111b). Since the membrane 130 is attached to the outer surface of the outer case 100 (the vent pipe 111b), visual inspection of the membrane 130 from the outside, maintenance work such as replacement or cleaning of the membrane 130, and the like are easy. By attaching the membrane 130 to the outer surface of the outer case 100 (the vent pipe 111b), peeling or falling-off of the membrane 130 caused by a rise in external pressure of the outer case 100 or by collision of foreign matter such as water with the membrane 130 can be suppressed.

Although the energy storage apparatus 10 according to the present example embodiment has been described above, the present invention is not limited to the above-described example embodiments. The example embodiments disclosed herein are illustrative in all respects and not restrictive, and the scope of the present invention includes all modifications within the meaning and scope of the claims and their equivalents.

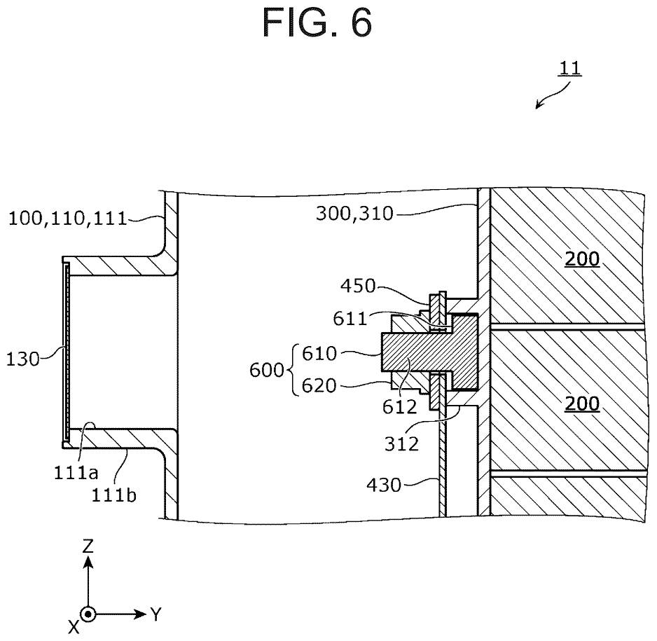

In the above example embodiments, the connecting portions 600 and 312 connect the inner case 300, the bus bar 430, the circuit board 500, the bus bar 440, and the bus bar 450, but it suffices if at least two elements among them are connected. FIG. 6 is a cross-sectional view illustrating a connection configuration and an arrangement position of connecting portions 600 and 312 included in an energy storage apparatus 11 according to Modification Example 1 of the present example embodiment. FIG. 6 is a view corresponding to FIG. 5A.

As illustrated in FIG. 6, in the present modification example, the connecting portions 600 and 312 connect the inner case 300, the bus bar 430, and the bus bar 450. Also in the present modification example, the connecting portions 600 and 312 are an example of a connecting portion disposed in the outer case 100 and connecting at least two elements in the outer case 100. At least a portion of the connecting portion 600 or 312 is disposed in the through hole 111a when viewed from the penetration direction of the through hole 111a. The shaft portion 612 of the bolt 610 extends in the penetration direction of the through hole 111a. Other configurations of the present modification example are the same as those of the above-described example embodiments, and thus detailed description thereof will be omitted. Also in the present modification example, effects similar to those of the above-described example embodiments are exhibited.

In the present modification example, the connecting portions 600 and 312 may connect only the inner case 300 and the bus bar 430, may connect only the inner case 300 and the circuit board 500, or may connect only the inner case 300 and the bus bar 450. The connecting portion 600 may connect only the bus bar 430 and the bus bar 450, may connect only the bus bar 430 and the circuit board 500, or may connect only the bus bar 450 (and 440) and the circuit board 500.

In the above example embodiments and Modification Example 1, the connecting portions 600 and 312 connect at least two elements among the inner case 300, the bus bar 430, the circuit board 500, the bus bar 440, and the bus bar 450, but any other elements may be connected. The connecting portions 600 and 312 may connect the energy storage device 200 and other elements, such as connecting the terminal 220 of the energy storage device 200 and the bus bar 400. The connecting portions 600 and 312 may connect at least two elements not illustrated in the above example embodiments and Modification Example 1, such as connectors of two harnesses (a harness connected to the outside, an internal harness, etc.) located in the outer case 100. That is, the connecting portions 600 and 312 may connect any elements as long as they are at least two elements included in the energy storage apparatus. An example thereof is shown below as Modification Example 2.

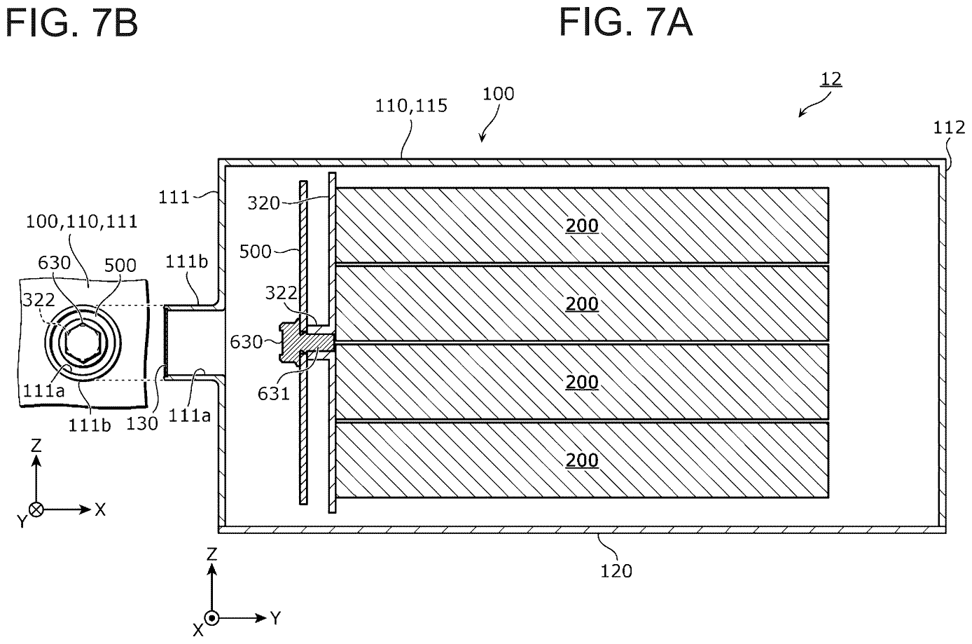

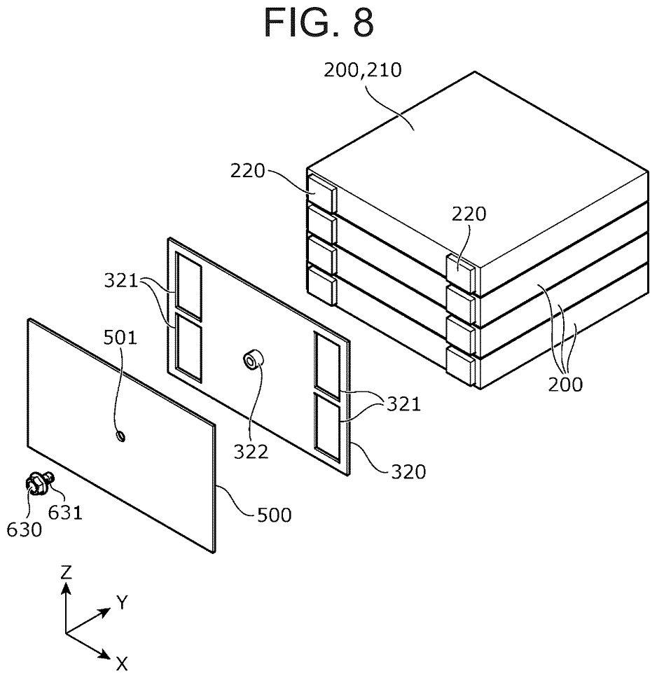

FIGS. 7A and 7B includes a cross-sectional view and a front view illustrating a connection configuration and an arrangement position of connecting portions 630 and 322 included in an energy storage apparatus 12 according to Modification Example 2 of the present example embodiment. FIG. 7A is a view corresponding to FIG. 4, and FIG. 7B is a view corresponding to FIG. 5B (illustration of the membrane 130 is omitted in FIG. 7B). FIG. 8 is an exploded perspective view illustrating respective elements when a configuration inside the outer case 100 of the energy storage apparatus 12 according to Modification Example 2 of the present example embodiment is exploded. FIG. 8 is a view corresponding to FIG. 3, but illustration of bus bars and the like is omitted, and configurations of the energy storage devices 200, a support 320, the circuit board 500, and the connecting portion 630 are illustrated.

As illustrated in FIGS. 7 and 8, in the present modification example, the connecting portion 630 connects the support 320 and the circuit board 500. The connecting portion 630 is a bolt including a shaft portion 631. The shaft portion 631 is a shaft body extending in the Y-axis positive direction and including a male screw portion.

The support 320 is a plate-shaped structure having a configuration similar to that of the inner case wall portion 310 of the inner case 300 in the above example embodiments. That is, the support 320 is provided with openings 321 into which the terminals 220 of the energy storage devices 200 are inserted, a connecting portion 322 to which the connecting portion 630 is connected, and an opening (not illustrated) through which gas discharged from the energy storage devices 200 passes. Although four openings 321 are provided in the support 320, five openings 321 may be provided similarly to the openings 311 of the inner case wall portion 310, and the number, size, shape, and the like of the openings 321 are not particularly limited.

The connecting portion 322 is a portion to which the shaft portion 631 of the connecting portion 630 is connected. The connecting portion 322 is a protruding portion disposed at the X-axis direction central portion and the Z-axis direction central portion of the support 320 and protruding in the Y-axis negative direction. A female screw portion is formed in a central portion of the connecting portion 322, and the connecting portion 630 is connected (fixed) to the connecting portion 322 by screwing the male screw portion formed on the shaft portion 631 into this female screw portion.

Specifically, the shaft portion 631 of the connecting portion 630 is inserted into the through hole 501 (see FIG. 8) of the circuit board 500 and penetrates the circuit board 500 in the Y-axis direction. Then, the shaft portion 631 is coupled with the connecting portion 322. Accordingly, the connecting portion 630 connects (joins) the circuit board 500 and the support 320 together with the connecting portion 322. That is, the connecting portion 630 connects at least two elements in the outer case 100 together with the connecting portion 322. Thus, in the present modification example, the connecting portions 630 and 322 are an example of a connecting portion disposed in the outer case 100 and connecting at least two elements in the outer case 100.

In such a configuration, at least a portion of the connecting portion 630 or 322 is disposed in the through hole 111a when viewed from the penetration direction of the through hole 111a. In the present modification example, the entire connecting portion 630 and connecting portion 322 are disposed in the through hole 111a when viewed from the penetration direction (the Y-axis direction) of the through hole 111a. The shaft portion 631 of the connecting portion 630 extends in the penetration direction (the Y-axis direction) of the through hole 111a. Central axes of the connecting portion 630 (shaft portion 631) and the connecting portion 322 coincide with the central axis of the through hole 111a (are coaxial), and the connecting portion 630 and the connecting portion 322 are disposed at the central portion (the center position) of the through hole 111a when viewed from the penetration direction (the Y-axis direction) of the through hole 111a. Other configurations of the present modification example are the same as those of the above-described example embodiments, and thus detailed description thereof will be omitted. Also in the present modification example, effects similar to those of the above-described example embodiments are exhibited.

In the present modification example, the support 320 may be a portion of an element similar to the inner case 300 in the above example embodiments (a portion corresponding to the inner case wall portion 310), or may be a bus bar holder holding the bus bar or the like. The connecting portion 630 may include a bolt and a nut similarly to the connecting portion 600 in the above example embodiments.

In the above example embodiments, the membrane 130 is attached to the outer surface of the outer case 100 (the outer surface of the vent pipe 111b), but it suffices if it is disposed at a position covering the through hole 111a. The membrane 130 may be attached to the inside of the vent pipe 111b, or may be attached to the inner surface of the outer case 100 (the inner surface of the outer case side wall 111).

In the above example embodiments, the energy storage apparatus 10 includes the membrane 130 and is configured to allow ventilation from the inside to the outside and from the outside to the inside of the outer case 100 via the through hole 111a and the membrane 130, but is not limited thereto. The energy storage apparatus 10 may be configured to allow only ventilation (exhaust) from the inside to the outside of the outer case 100, or only ventilation (intake) from the outside to the inside. The energy storage apparatus 10 may not include the membrane 130, and may be configured to allow ventilation between the inside and the outside of the outer case 100 via the through hole 111a. The membrane 130 may not have air permeability, and may be a structure that breaks and/or moves so as to open the through hole 111a when the internal pressure of the outer case 100 becomes excessively large. That is, the energy storage apparatus 10 may include a valve (pressure relief valve, safety valve), in place of or together with the membrane 130, that normally closes the through hole 111a and is configured to allow ventilation between the inside and the outside of the outer case 100 when the internal pressure of the outer case 100 becomes large. Even with this valve, it can be said that the energy storage apparatus 10 is configured to allow ventilation between the inside and the outside of the outer case 100 via the through hole 111a.

In the above example embodiments, the through hole 111a (the vent pipe 111b) is provided at the X-axis direction central portion and the Z-axis direction central portion of the outer case side wall 111 of the case main body 110, but is not limited thereto. The through hole 111a (the vent pipe 111b) may be provided at any position on the outer case side wall 111 as long as at least a portion of the connecting portion 600 or 312 is disposed in the through hole 111a when viewed from the penetration direction of the through hole 111a. The through hole 111a (the vent pipe 111b) may be provided in any one of the outer case side walls 112 to 114 and the outer case upper wall 115 of the case main body 110, or may be provided in the case lid body 120.

In the above example embodiments, the outer case 100 (the outer case side wall 111 of the case main body 110) includes the vent pipe 111b and the vent pipe 111b includes the through hole 111a, but the outer case 100 may not include the vent pipe 111b. In this case, the through hole 111a may be a through hole formed in the outer case 100 (the outer case side wall 111 of the case main body 110, etc.).

In the above example embodiments, the connecting portion 312 is provided on the inner case wall portion 310 of the inner case 300, but may be provided on a flat plate-shaped structure such as the support 320 in the above Modification Example 2, or a bus bar holder or the like holding the bus bar 400. In this case, the energy storage apparatus 10 may not include the inner case 300.

In the above example embodiments, the connecting portion 600 is fixed to the connecting portion 312 by being inserted (fitted) into the connecting portion 312, but the connecting portion 600 and the connecting portion 312 may be fixed by inserting (fitting) the connecting portion 312 into the connecting portion 600. The connecting portion 600 and the connecting portion 312 may be fixed by adhesion, fusion bonding, welding, or the like.

In the above example embodiments, the entire connecting portions 600 and 312 are disposed in the through hole 111a when viewed from the penetration direction of the through hole 111a, but only a portion of the connecting portion 600 or 312 may be disposed in the through hole 111a.

In the above example embodiments, the bolt 610 of the connecting portion 600 includes the shaft portion 612 extending in the Y-axis direction, but the shaft portion 612 may extend in a direction different from the Y-axis direction, such as a direction inclined with respect to the Y-axis direction, the X-axis direction, or the Z-axis direction. In this case, the bolt 610 connects at least two elements in the outer case 100 by coupling with the nut 620 in the direction different from the Y-axis direction (the direction in which the shaft portion 612 extends).

In the above example embodiments, the connecting portion 600 connects at least two elements in the outer case 100 by coupling the bolt 610 with the nut 620, but is not limited thereto. The connecting portion 600 may connect the at least two elements by sandwiching them, may connect the at least two elements by being fitted to the at least two elements, or may connect the at least two elements by engaging with the at least two elements. The connecting portion 600 may be a bonded portion (adhesive or double-sided tape, etc.) when the at least two elements are connected (joined) by adhesion using an adhesive, a double-sided tape, or the like. The connecting portion 600 is not an element separate from the at least two elements, but may be a fitting portion when the at least two elements are fitted, or an engaging portion when the at least two elements are engaged. The connecting portion 600 may be a welded portion (a fused portion) when the at least two elements are connected (joined) by welding such as laser welding, or a bonded portion when the at least two elements are connected (joined) by fusion bonding such as thermal bonding. The connecting portion 600 may connect the at least two elements by bringing them into contact with each other, instead of joining (fixing) and connecting the at least two elements. They may be merely in contact for rotation stopping, electrical connection, or the like.

Example embodiments constructed by arbitrarily combining elements, features, structures, characteristics, steps, etc., included in the above-described example embodiments and the modification examples thereof are also included in the scope of the present invention.

Example embodiments of the present invention can be applied to energy storage apparatuses including energy storage devices such as lithium-ion secondary batteries.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
an energy storage device;
a case that accommodates the energy storage device and that includes a through hole; and
a connecting portion positioned in the case to connect at least two elements in the case; wherein the through hole allows ventilation between an inside and an outside of the case; and
at least a portion of the connecting portion is located in the through hole when viewed from a penetration direction of the through hole.

2. The energy storage apparatus according to claim 1, wherein the connecting portion includes a shaft portion extending in the penetration direction of the through hole.

3. The energy storage apparatus according to claim 1, wherein the case includes a vent pipe including the through hole.

4. The energy storage apparatus according to claim 1, wherein the case includes a membrane that covers the through hole and has air permeability.

5. The energy storage apparatus according to claim 4, wherein the membrane is attached to an outer surface of the case around the through hole.
